(19) United States
(12) Patent Application Publication
(10) Pub. No.: US 2016/0116600 A1
(43) Pub. Date: Apr. 28, 2016

(54) METHOD AND SYSTEM FOR 3D POSITION ESTIMATION OF A GNSS RECEIVER USING TRAVEL TIME MEASUREMENTS

(71) Applicant: Umm AI-Qura University, Makkah (SA)

(72) Inventor: Mohamed KHALAF-ALLAH, Makkah (SA)

(73) Assignee: Umm AI-Qura University, Makkah (SA)

(21) Appl. No.: 14/687,701

(22) Filed: Apr. 15, 2015

Related U.S. Application Data
(63) Continuation of application No. PCT/IB2014/002237, filed on Oct. 27, 2014.

(51) Int. Cl. G01S 19/42

(52) U.S. Cl. CPC G01S 19/42

(57) ABSTRACT

A system and associated methodology determines the 3D position of a Global Navigation Satellite System (GNSS) receiver using travel times of a signal. In addition, the system determines a clock offset between the GNSS receiver and satellites. The system finds the required coordinate component while minimizing the computational requirement.

### CROSS-REFERENCE TO RELATED APPLICATIONS

This application claims the benefit of priority from International PCT Application No. PCT/IB2014/002237 filed Oct. 27, 2014, the entire contents of which are incorporated herein by reference.

### BACKGROUND

The proliferation of wireless and mobile devices has promoted the demand for context-aware applications, in which location is viewed as one of the most significant contexts. In addition, accurately determining a 3D position of an object is needed in many situations such as in aircrafts, vehicles and mobile devices location systems. A commonly used method for object localization is trilateration. Typically, a trilateration based object localization system makes use of Time of Arrival measurements from three reference stations. One drawback of trilateration is an ambiguity that arises in one of the 3D components. The ambiguity cannot be resolved without prior knowledge of the location of the object. Another drawback of trilateration is the difficulty in solving the nonlinear system of equations involved. For the 2D case, some of the methods to solve the nonlinear system are described in: B. Saduon and O. Al-Bayari, “Location based services using geographical information systems,” Computer Communications, vol. 30, 2007, pp. 3154-3160, Y. Zhao, “Standardization of mobile phone positioning for 3G systems,” IEEE Communication Magazine, 2002, pp. 106-108, Y. T. Chan, “A simple and efficient estimator or hyperbolic location,” IEEE Transactions on Signal Processing, vol. 42, no. 8, 1994, pp. 1905-1915, S. Tekinay, E. Chao, and R. Richton, “Performance benchmarking for wireless location systems,” IEEE Communication Magazine, 1998, pp. 72-76, J. Caffery Jr., “A new geometry approach to TOA location,” IEEE Vehicular Technology Conference, IEEE VTS Fall 2000, vol. 4, 2000, pp. 1943-1949, S. Venkatraman, and J. Caffery Jr., “Hybrid TOA/AOA techniques for mobile location in non-line-of-sight environments,” IEEE wireless communications and Networking Conference (WCNC'04), vol. 1, 2004, pp. 274-278, K. W. Cheung, H. C. SO, W. K. Ma, and Y. T. Chan, “Least squares algorithms for time of arrival based mobile location,” IEEE Transactions on Signal Processing, vol. 52, no. 4, 2004, pp. 1121-1128, S. Venkatraman, J. Caffery Jr., and H. R. You, “A novel TOA location algorithm using LOS range estimation for NLOS environments,” IEEE Transactions on Vehicular Technology, vol. 53, no. 5, 2004, pp. 1515-1524, S. Fischer, H. Grubeck, A. Kangas, H. Koorapaty, E. Larsson, and P. Lundqvist, “Time of arrival estimation of narrowband TDMA signals for mobile positioning,” IEEE International Symposium on Personal, Indoor and Mobile Radio Communications, vol. 1, 1998, pp. 451-455, P. N. Pathirana, A. V. Savkin, S. Jha, “Location estimation and trajectory prediction for cellular networks with mobile base stations,” IEEE Transactions on Vehicular Technology, vol. 53, no. 6, 2004, pp. 1903-1913, S. Al-Jazzar, J. Caffery, H. R. You, “Scattering-model-based methods for TOA location in NLOS environments,” IEEE Transactions on Vehicular Technology, vol. 56, no. 2, 2007, pp. 583-593, and A. Y. Olenko, K. T. Wong, S. A. Qasmi, and J. Ahmadi-Shokouh, “Analytically derived uplink/downlink TOA and 2D-DOA distribution with scatters in 3D hemispheroid surrounding the mobile,” IEEE Transactions on Antennas and Propagation, vol. 54, no. 9, 2006, pp. 2446-2454 each incorporated herein by reference in its entirety. For the 3D case, some methods are describe in: Q. Wan and Y. N. Peng, “An improved 3-dimensional mobile location method using volume measurements of tetrahedron,” The 4^{th} World Congress on Intelligent Control and Automation, Shanghai, China, June 2002, pp. 2181-2185, F. Thomas, and L. Ros, “Revisiting trilateration for robot localization,” IEEE Transactions on Robotics, vol. 21, no. 1, 2005, pp. 93-101, I. Jami, M. Ali, and R. F. Ormandroyd, “Comparison of methods of locating and tracking cellular mobiles,” Novel methods of location tracking of cellular mobiles and their system applications, IEE Colloquium, London, UK, 1999, D. E. Manolakis, “Efficient solution and performance analysis of 3D position estimation by trilateration,” IEEE Transactions on Aerospace and Electronic Systems, vol. 32, no. 4, 1996, pp. 1239-1248, J. Zhou, J. K. Yin Ng, “Mobile location estimation using a 3-dimension ellipse propagation model,” Technical Report: COMP-04-006, Dept. of Computer Science, Hong Kong Baptist University, 2004, G. Shen, R. Zetik, and R. S. Thoma, “Performance comparison of TOA and TDOA based location estimation algorithms in LOS environment,” 5^{th} Workshop on Positioning, Navigation and Communication (WPNC'08), 2008, pp. 71-78, J. R. Gonzalez, and C. J. Bleakley, “Accuracy of spread spectrum techniques for ultrasonic indoor location,” International Conference on Digital Signal Processing (ICDSP 2007), 2007, pp. 284-287, and C. P. Yen, and P. J. Volts, “Direct Location Estimation using Indoor Wireless Communication Systems,” Applications and Technology Conference 2007, Long Island, May 2007, pp. 1-5, each incorporated herein by reference in its entirety. Statistical approaches are described in W. H. Foy, “Position location solutions by Taylor series estimation,” IEEE transactions on Aerospace and Electronic Systems, vol. 12, no. 2, March 1976, pp. 187-194 incorporated herein by reference in its entirety. Other methods are described in I. Guvenc and C. C. Chong, “A survey on TOA based wireless localization and NLOS Mitigation Techniques,” IEEE communications Surveys & Tutorials, vol. 11, no. 3, 3^{rd} QUARTER 2009 incorporated herein by reference in its entirety. In addition, in many applications, the 3D position of the object needs to be found using limited computational and power resources. Due to the reasons mentioned above there is a need for a method and system that requires minimal processing power, uses existing technologies and provides the exact 3D location.

A global navigation satellite system (GNSS) is a space-based satellite radio navigation system that provides three-dimensional (3-D) receiver positioning by solving a set of nonlinear equations using pseudorange measurements. The current approach of solving the nonlinear equations is to linearize the pseudorange equations and calculate the receiver position iteratively, starting with an initial position guess. For near-earth navigation, the center of the earth is usually used as a good initial position guess to make iterative algorithms converge to the position solution. Non-iterative closed-form (CF) and direct solutions to the nonlinear pseudorange GNSS equations provide potential improvements. A direct solution that does not require an initial position guess is attractive for space navigation and for unusual planar array configurations using pseudo-satellites (pseudolites), where the iterative procedure is sensitive to the initial position guess as described in: J. McKay, “Optimization of a GPS-Based Navigation Reference System,” MS Thesis, School of Engineering, Air Force Institute of Technology, Wright-Patterson AFB, OH, 1996 and M. Pachter, and J. McKay, “Geometry Optimization of a GPS-Based Navigation System,” Navigation: Journal of the institute of Navigation, vol. 44, no. 4, 457-470, winter 1997-1998 each incorporated herein by reference in its entirety. Moreover, solutions that require fewer iterations and floating-point operations (FLOPS) are attractive for high-speed vehicles, e.g. spacecrafts, where the computational and power resources may be limited. This results in reduced time to first fix (TTFF), which also helps to acquire more measurements quickly. CF solutions have been developed and described in: S. Bancroft, “An algebraic Solution of the GPS equations,” IEEE Transactions on Aerospace an Electronic Systems, vol. 21, no. 1, pp. 56-59, 1985, J. Leva, “An alternative closed-form solution to the GPS Pseudo-Range Equations,” IEEE Transactions on Aerospace and Electronic Systems, vol. 32, no. 4, pp. 1430-1439, 1996, L. Krause, “A Direct Solution to GPS Type Navigation Equations,” IEEE Transactions on Aerospace and Electronic Systems, vol. 23, no. 2, pp. 223-232, 1987, J. Abel and J. Chaffee, “Existence and Uniqueness of GPS solutions,” IEEE transactions on Aerospace and Electronic Systems, vol. 27, no. 6, pp. 952-956, 1991, J. Chaffee and J. Abel, “On the Exact Solutions of Pseudorange Equations,” IEEE Transactions on Aerospace and Electronic systems, vol. 30, no. 4, pp. 1021-1030, 1994, J. Hoshen, “The GPS Equations and the Problem of Apollonius,” IEEE Transactions on Aerospace and Electronic Systems, vol. 32, No. 3, pp. 1116-1124, 1996, S. Nardi, and M. Pachter, “GPS Estimation Algorithm Using Stochastic Modeling,” Proceedings of the Conference on Decision and Control, Tampa, Fla., USA, 1998, and M. Pachter, and S. Nardi, “Stochastic Modeling in GPS Estimation,” Advances in Intelligent System: Concepts, Tools, and Applications, Kluwer Academic, vol. 35, pp. 389-400, 1999, each incorporated herein by reference in its entirety.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

A method for determining a 3D position of a Global Navigation Satellite System (GNSS) receiver is provided that comprises obtaining a first, a second, a third, a fourth, and a fifth travel times of a signal from a first, a second, a third, a fourth, and a fifth satellites, determining the 3D position of the GNSS receiver as a function of the first, the second, the third, the fourth, and the fifth travel times of the signal from the first, the second, the third, the fourth, and the fifth satellites, and positions of the first, second, third, fourth, and fifth satellites, determining a clock offset between synchronized clocks of the first, the second, the third, the fourth, and the fifth satellites and a clock of the GNSS receiver and sending the 3D position of the GNSS receiver and the clock offset to an external device to provide enhanced accurate position data to host applications.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram that shows an object and four stations according to one example;

FIG. 2 is an exemplary block diagram of a station according to one example;

FIG. 3 is a schematic diagram of a 3D position estimating system according to one example;

FIG. 4 is a flow chart showing a method for determining a 3D position of the object according to one example;

FIG. 5 is a table showing a list of stations according to one example;

FIG. 6 is a flow chart showing a method for determining the 3D position of the object according to one example;

FIG. 7 is an exemplary block diagram of a server according to one example;

FIG. 8 is a schematic diagram of the 3D position estimating system according to one example; and

FIG. 9 is a flow chart showing a method for determining the 3D position of the object according to one example.

### DETAILED DESCRIPTION

Referring now to the drawings, wherein like reference numerals designate identical or corresponding parts throughout several views, the following description relates to determining a 3D object position using measurements from four stations. Specially, as shown in the drawings and related discussion, in one embodiment, the measurements from the four stations are sent to a server. The server, using processing circuitry, determines the 3D object position. Then, the server can send the 3D object position to a user.

Since recent technological advances have enabled the development of low cost, low power and multifunctional sensor devices, many systems use localization information to provide directions and services related to the user's current location. For example, cellular operators use location information to find the source of emergency calls. Location information is also essential for wirelessly tracking objects such as vehicles and valuable goods. There are several techniques for localization using data, such as the time when signals arrives and the received signal strength.

Time of Arrival (TOA) method uses a travel time from a transmitter to a receiver to measure the distance between the two. Since the TOA method relies on the difference between a time of arrival and a time of departure, all receivers and transmitters must be synchronized so there in no error due to clock offsets. TOA measurements are also used in locating cell phones and for seismological studies. The TOA method is based on time of flight (TOF) principle of distance measurement where the sensed parameter, time interval, is converted to distance by multiplication by the speed of propagation. In the TOA method, location estimates are found by determining points of intersections of circles (2D case) or spheres (3D case) whose centers are located at fixed stations and radii are estimated distances to an object. Trilateration is the determination of the 3D object position using three stations at known locations. In trilateration, a solution of a system of quadratic equations is involved where an exact solution is not easy to obtain. However, many algebraic and numerical solutions are available. These approaches involve complex geometric computations, which usually require a relatively long execution time and thus are not suitable for low-cost applications with constrained power and computational resources. In addition, algorithms that use three TOA measurements with three stations to obtain a 3D position solution face a twofold ambiguity and can be only be resolved if some information about the object general location is available. Described herein is an efficient and computational cost effective method and system for determining the 3D object position.

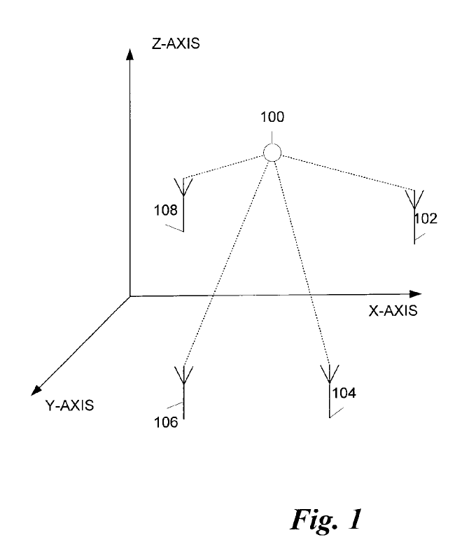

FIG. 1 is a schematic representation of a 3D position estimation system. The position of the object 100 is determined by the 3D position estimation system. As shown in FIG. 1, the system can be configured in a 3D rectangular coordinate system. The system consists of four stations 102,104,106,108 as shown in FIG. 1. The stations are arranged at different axis coordinates. The object 100 can comprise any object that can be detected by the stations 102,104,106,108. In selected embodiments, the object 100 may be an aircraft, a missile, a satellite, a vehicle, or the like. In other embodiments, the object 100 may be any type of electronic device capable of being detected by the stations 102,104,106,108. For example, the object 100 can be a cellular telephone, a paging device, a GPS receiver, or the like. Each of the four stations 102,104,106,108 is equipped with at least one sensor. Each station can be equipped with many sensors to detect different type of objects. In selected embodiments, the sensor type can depend on the type of position determining system being employed. For example, the position determining system like radar, sonar, GPS, cellular and the like, each employ appropriate types of sensors to detect the relevant signals. In selected embodiments, the object location system may be contained at least in part in a spacecraft or aircraft such as MILSTAR satellite or JSTARS aircraft. Each of the four stations 102,104,106,108 is equipped with a clock.

A transmitted or reflected signal from the object 100 is received by each of the sensors at stations 102,104,106,108. The time of arrival for the signal from the object 100 to each station is recorded. A range measurement from the object 100 to each of the station can be calculated based on the TOA and a signal propagation speed in a media. In one embodiment, the range measurement from the object 100 to each of the station is found by multiplying the TOA by the signal propagation speed in the media. In selected embodiments, the signal propagation speed in the media is the speed of light for electromagnetic based systems and the speed of sound in that medium for sonar based systems.

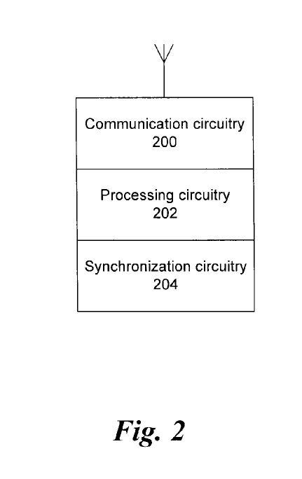

FIG. 2 is a block diagram showing the station components according to one example. Each station may include communication circuitry 200, processing circuitry 202 and synchronization circuitry 204 as would be understood by one of ordinary skill in the art. The synchronization circuitry 204 is responsible of the synchronization of the clocks of stations 102,104,106, 108. The communication circuitry 200 sends and receives data. The processing circuitry 202 receives data from the sensor. In selected embodiments, the processing circuitry 202 calculates the range measurements as described above.

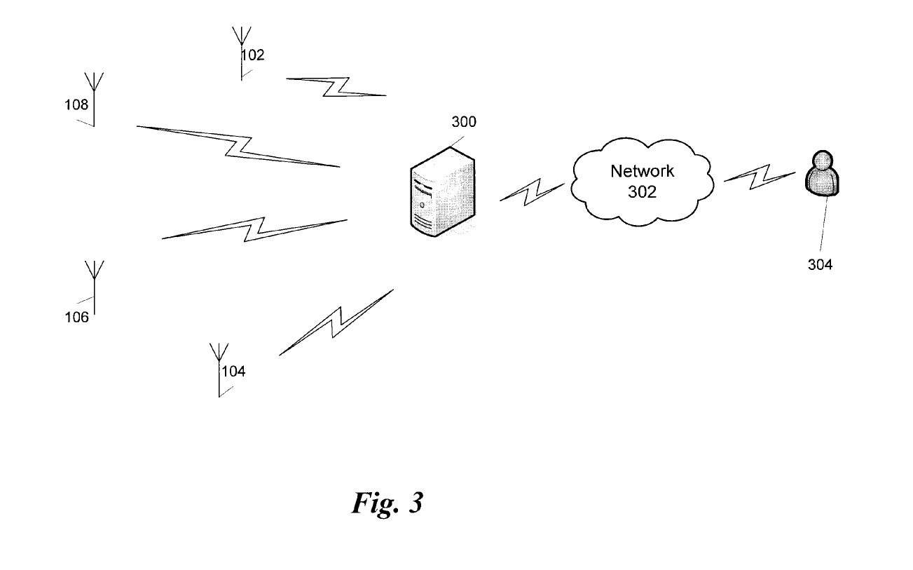

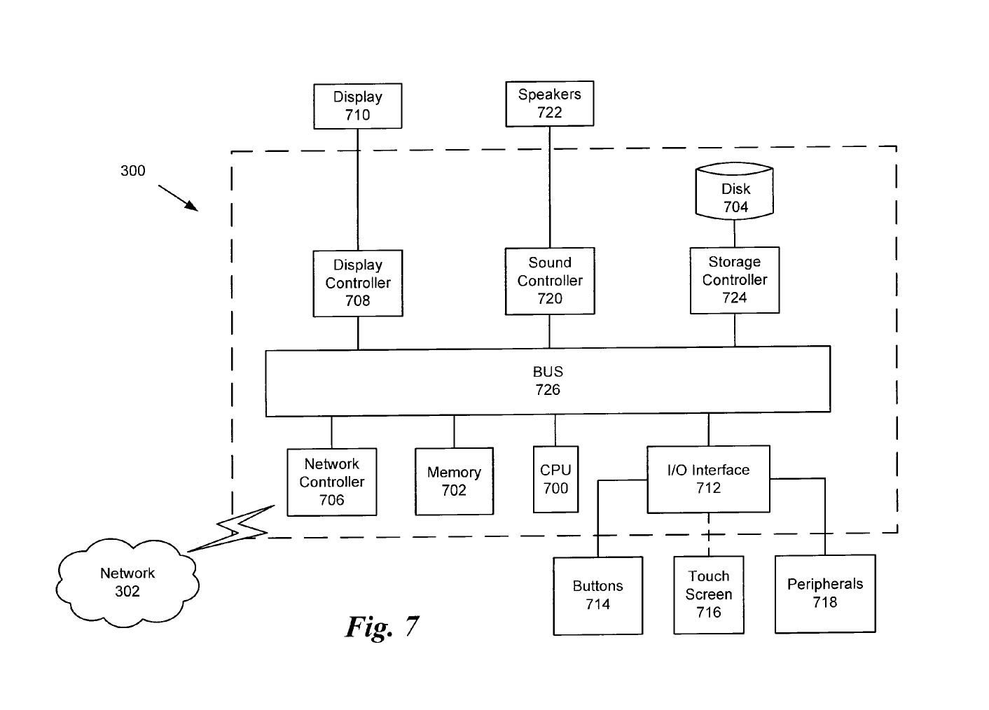

FIG. 3 is a schematic representation of the 3D position estimation system according to one example. The stations 102, 104, 106, 108 may connect via communication circuitry 200 to the server 300 to transmit and receive data. The stations 102,104,106, 108 may transmit the range measurements calculated by the processing circuitry 202 to the server 300. The server 300 includes a CPU 700 as shown in FIG. 7. The user 304 may connect via the network 302 to the server 300. The user 304 may send via the network 302 data such as information about the object that needs to be located. The information may indicate the type of the object that needs to be localized. The user may also indicate which coordinate is needed. The CPU 700 may use a table that lists the type of sensors available in each station to choose the four stations. The table may be stored in the server 300. In selected embodiments, the table may also include a status indicating the availability of the station. For example, a particular station may be down for maintenance and therefore may not be used to detect the object 100. The network 302 is any network that allows the server 300 and the user 304 to communicate data with each other such as a Wide Area Network, Local Area Network or the Internet. The server 300 is one or more servers that respond to requests across a computer network and processes information. In selected embodiments, the stations 102, 104, 106, 108 may send, via the communication circuitry 200, TOA measurements to the server 300. Then, the server 300 may calculate the range measurements using the CPU 700. The user 304 is one or more users trying to locate the object 100. The user 304 may be a mobile device application or other software trying to locate the object 100. In other embodiments, the user 304 may be the owner of the mobile device being located. The object 100 may be part of a group of objects that needs to be located.

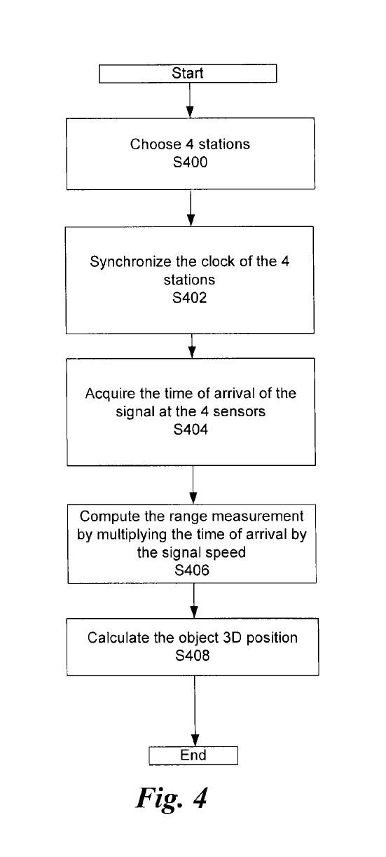

FIG. 4 is a flowchart that illustrates the method to find the 3D position of the object 100 according to one example. At step S400, the server 300 may choose the four stations that need to be used to find the 3D position. In other embodiments, the user may indicate which four stations should be used. For example, the user may be interested in the area (region) covered by those stations. In this example, it is assumed that the stations positions are known. In selected embodiments, stations 102, 104, 106, 108 are located at (x₁, y₁, z₁), (x₂, y₂, z₂), (x₃, Y₃, z₃), and (x₄, y₄, z₄) respectively in the 3-dimensional rectangular coordinate system. The coordinates (x₁, y₁, z₁), (x₂, y₂, z₂), (x₃, y₃, z₃), and (x₄, y₄, z₄) can be stored in the server 300. In selected embodiments, the station 102 may represent the reference of the 3-dimensional rectangular coordinate system.

At step S402, the clocks of the four stations and the object are synchronized using the synchronization circuitry 204. In one embodiment, the synchronization method may be that disclosed in U.S. Pat. No. 5,469,409, entitled “METHOD FOR CLOCK CALIBRATION IN A POSITION DETERMINATION SYSTEM” the entire disclosure of which is incorporated herein by reference.

At step S404, the server 300 may obtain the time of arrival of the signal from stations 102, 104, 106 and 108. At step 406, the server 300 using processing circuitry computes the range of measurement based on the time of arrival and the signal speed in the medium. In selected embodiments, the server 300 can compute the range of measurement by multiplying the time of arrival and the signal speed in the medium. In selected embodiments, the signal may be reflected or transmitted from the object 100. In other embodiments, the signal can be received and re-transmitted by the object 100. At step S408, the server 300 can compute the 3D position of the object 100. The unknown location of the object 100 may be defined in the 3-dimensional rectangular coordinate system as (x,y,z).

The equations of the four available TOA measurements may be written as

(x−x₁)²+(y−y₁)²+(z−z₁)²=r₁² (1)

(x−x₂)²+(y−y₂)²+(z−z₂)²=r₂² (2)

(x−x₃)²+(y−y₃)²+(z−z₃)²=r₃² (3)

(x−x₄)²+(y−y₄)²+(z−z₄)²=r₄² (4)

Subtracting equations (2), (3) and (4) from equation (1), three expressions are obtained:

$$\begin{matrix}( {x}_{2} - {x}_{1} ) x + ( {y}_{2} - {y}_{1} ) y + ( {z}_{2} - {z}_{1} ) z = \frac{1}{2} {A}_{1} & ( 5 ) \\ ( {x}_{3} - {x}_{1} ) x + ( {y}_{3} - {y}_{1} ) y + ( {z}_{3} - {z}_{1} ) z = \frac{1}{2} {A}_{2} & ( 6 ) \\ ( {x}_{4} - {x}_{1} ) x + ( {y}_{4} - {y}_{1} ) y + ( {z}_{4} - {z}_{1} ) z = \frac{1}{2} {A}_{3} \\ where & ( 7 ) \\ {A}_{1} = ( {r}_{1}^{2} - {r}_{2}^{2} ) + ( {x}_{2}^{2} - {x}_{1}^{2} ) + ( {y}_{2}^{2} - {y}_{1}^{2} ) + ( {z}_{2}^{2} - {z}_{1}^{2} ) & ( 8 ) \\ {A}_{2} = ( {r}_{1}^{2} - {r}_{3}^{2} ) + ( {x}_{3}^{2} - {x}_{1}^{2} ) + ( {y}_{3}^{2} - {y}_{1}^{2} ) + ( {z}_{3}^{2} - {z}_{1}^{2} ) & ( 9 ) \\ {A}_{3} = ( {r}_{1}^{2} - {r}_{4}^{2} ) + ( {x}_{4}^{2} - {x}_{1}^{2} ) + ( {y}_{4}^{2} - {y}_{1}^{2} ) + ( {z}_{4}^{2} - {z}_{1}^{2} ) & ( 10 )\end{matrix}$$

to cancel out z, equations (5) and (6) are first multiplied by (z₃−z₁) and (z₂−z₁) respectively, and then (6) is subtracted from (5). Rearranging the resultant to get y explicitly, yields

$$y = \frac{\frac{1}{2} {I}_{3} - x {I}_{1}}{{I}_{5}} \qquad ( 11 )$$

Repeating the previous step by multiplying equations (5) and (7) by (z₄−z₁) and (z₂−z₁) respectively, and then rearranging the expression resulting from subtracting (7) from (5), yields another expression for y as:

$$y = \frac{\frac{1}{2} {I}_{4} - x {I}_{2}}{{I}_{5}} \qquad ( 12 )$$

An expression for x is obtained from (11) and (12) in terms of the given information and independent of the other two position components as:

$$x = \frac{1}{2} \frac{{I}_{4} {I}_{5} - {I}_{3} {I}_{6}}{{I}_{2} {I}_{5} - {I}_{1} {I}_{6}} \qquad ( 13 )$$

where
I₁=(z₃−z₁)(x₂−x₁)−(z₂−z₁)(x₃−x₁),
I₂=(z₄−z₁)(x₂−x₁)−(z₂−z₁)(x₄−x₁),
I₃=(z₃−z₁)A₁−(z₂−z₁)A₂,
I₄=(z₄−z₁)A₁−(z₂−z₁)A₃,
I₅=(z₃−z₁)(y₂−y₁)−(z₂−z₁)(y₃−y₁), and
I₆=(z₄−z₁)(y₂−y₁)−(z₂−z₁)(y₄−y₁),

In a similar way, expressions for y and z may be obtained independently from the other two respective position components as:

$$\begin{matrix}y = \frac{1}{2} \frac{{I}_{1} {I}_{4} - {I}_{2} {I}_{3}}{{I}_{1} {I}_{6} - {I}_{2} {I}_{5}} & ( 14 ) \\ z = \frac{1}{2} \frac{{I}_{7} {I}_{10} - {I}_{8} {I}_{9}}{{I}_{7} {I}_{12} - {I}_{8} {I}_{11}} & ( 15 )\end{matrix}$$

where
I₇=(y₃−y₁)(x₂−x₁)−(y₂−y₁)(x₃−x₁),
I₈=(y₄−y₁)(x₂−x₁)−(y₂−y₁)(x₄−x₁),
I₉=(y₃−y₁)A₁−(y₂−y₁)A₂,
I₁₀=(y₄−y₁)A₁−(y₂−y₁)A₃,
I₁₁=(y₃−y₁)(z₂−z₁)−(y₂−y₁)(z₃−z₁) and
I₁₂=(y₄−y₁)(z₂−z₁)−(y₂−y₁)(z₄−z₁),

Equations (13), (14) and (15) can be used to calculate the 3D position of the object 100 at step S408. Then, the server 300 can send the coordinates to the user 304 via the network 302. The server 300 may send the 3D position of the object 100 to an external device to provide accurate position data to host applications. The accurate position data may be used by smartphone applications. The 3D position of the object 100 found has no ambiguities as in the methods that use three stations. The computation of each position component is independent of the other components. For example, the server 300 may find the x coordinate independently of the y and z coordinates. Thus, the method has the advantage of calculating the position component of interest only, for example, the vertical position (altimeter mode). The method can also be used to initiate more computationally intensive iterative positioning algorithms to help overcome divergence problems.

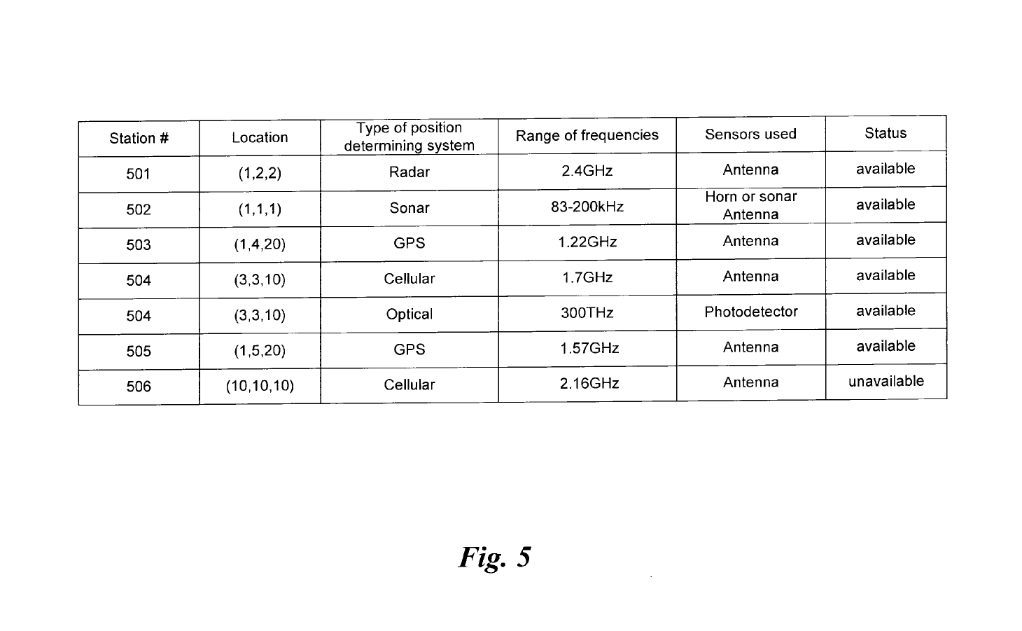

FIG. 5 is a table showing the different information stored in the server 300 according to one example. In selected embodiments, the table contains a station identification number, a station location, a type of position determining system, a range of frequencies, a sensor type, and a status. For example, the table shows that station 501 uses a radar based position system with a frequency of 2.4 GHz and the sensor type used is an antenna. The processing circuitry may analyze the information to choose the four stations at step S400. The analysis may include the status of the station, the type of position determining system used and the range of frequencies. In selected embodiments, the CPU 700 may choose the four stations with the most precise clock synchronization system (not shown). The clock synchronization is directly related to accuracy of the position. For example, if the accuracy is to be of the order of 1-2 m then the clock synchronization should be accurate to a nanosecond or better. The accuracy of each station may be also stored in the server 300. The CPU 700 may use additional information as would be understood to one of ordinary skill in the art. For example, the processing circuitry may not choose station that use GPS based position determining system during inclement weather or when a clear line of sight is not available.

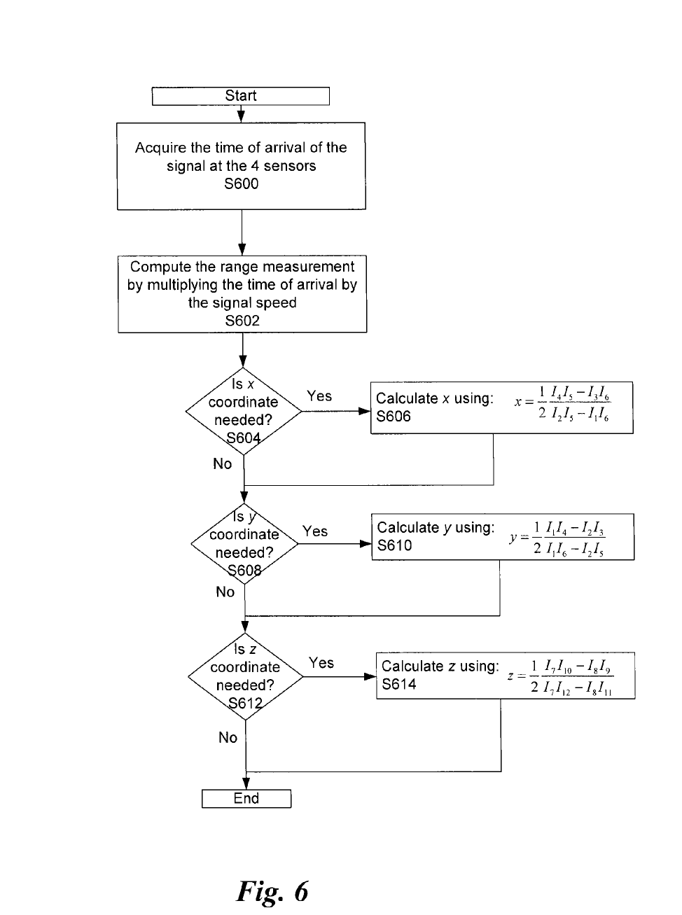

FIG. 6 is a flowchart showing the method for determining location according to one example. At step S600, the time of arrival of the signal can be sent, from the stations 102, 104, 106, 108 via the communication circuitry 200, to the server 300. At step S602, the server 300 using the processing circuitry can compute the range measurement. At step S604, the processing circuitry may check whether the x coordinate of the object is needed. The user 304 may indicate which coordinates are needed to the server 300 via the network 302. The user 304 depending on the application may need only one coordinate from x, y and z coordinates. At step S606, in response to determining that the x coordinate is needed, the x coordinate is calculated using equation (13). In response to determining that the x coordinate is not needed, then the process goes to step S608. At step S608, the server 300 may check whether the y coordinate is needed. In response to determining that the y coordinate is needed the process goes to step S610. At step S610, the y coordinate is found using equation (14). In response to determining that the y coordinate is not needed then the process goes to step S612. At step S612, the server 300 may check whether the z coordinate is needed. In response to determining that the z coordinate is needed then the process goes to step S614. At step S614, the z coordinate is calculated using equation (15).

In selected embodiments, the user may indicate the coordinate that needs to be determined for a group of objects. The user using an interface may enter the coordinate needed only once along with the group of objects that needs localization. For example, the user may be interested in the z coordinates. In other example, the user may be interested in two the x and y coordinates as in tracking ships. In selected embodiments, the user may indicate the area to detect any object presents. The user may also indicate using the interface, the period of time when the location should be determined. The server 300 then gets the TOA measurements from the four stations during the indicated period.

In selected embodiments, the disclosed system and associated methodology may be an indoor positioning system. The type of position determining system may be based on radio-frequency identification. The object may be equipped with a RFID reader and the stations may be equipped with RFID tags. For example, the stations may be fixed objects in the surrounding environment whose positions are known and stored in the server 300. Once the object moves inside the surrounding of the RFID tags its position can be calculated using steps S400-S408.

FIG. 7 is an exemplary block diagram of the server 300 according to one embodiment. In FIG. 7, the server includes a CPU 700 which performs the processes described above. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The server in FIG. 7 also includes a network controller 706, such as an Intel Ethernet PRO network interface card from Intel Corporation of America, for interfacing with network 302. As can be appreciated, the network 302 can be a public network, such as the Internet, or a private network such as an LAN or WAN network, or any combination thereof and can also include PSTN or ISDN sub-networks. The network 302 can also be wireless such as a cellular network including EDGE, 3G and 4G wireless cellular systems. The wireless network can also be WiFi, Bluetooth, or any other wireless form of communication that is known.

The server further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the server, such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the mobile device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

In other embodiments, the system may be used for the estimation of a 3D GNSS receiver position. A GNSS receiver determines its position using satellites. The 3D GNSS receiver position may be defined in the 3-dimensional rectangular coordinate system as x, y, z. The GNSS receiver measures the transmitting time of GNSS signal emitted from the satellites known as pseudorange measurements of the GNSS receiver. The pseudorange measurements may be used to construct a system of quadratic (nonlinear) equations. In addition, a clock-offset τ exists between the synchronized clocks of the satellites and the GNSS receiver's clock. Therefore, for a direct unambiguous analytical solution, five such equations can be used to estimate four unknowns (x, y, z, τ) and to eliminate the resulting ambiguity due to the quadratic nature of the equations. With the extra pseudorange measurements, several sets of five measurements can be formed and utilized to improve the estimation accuracy and fault detection.

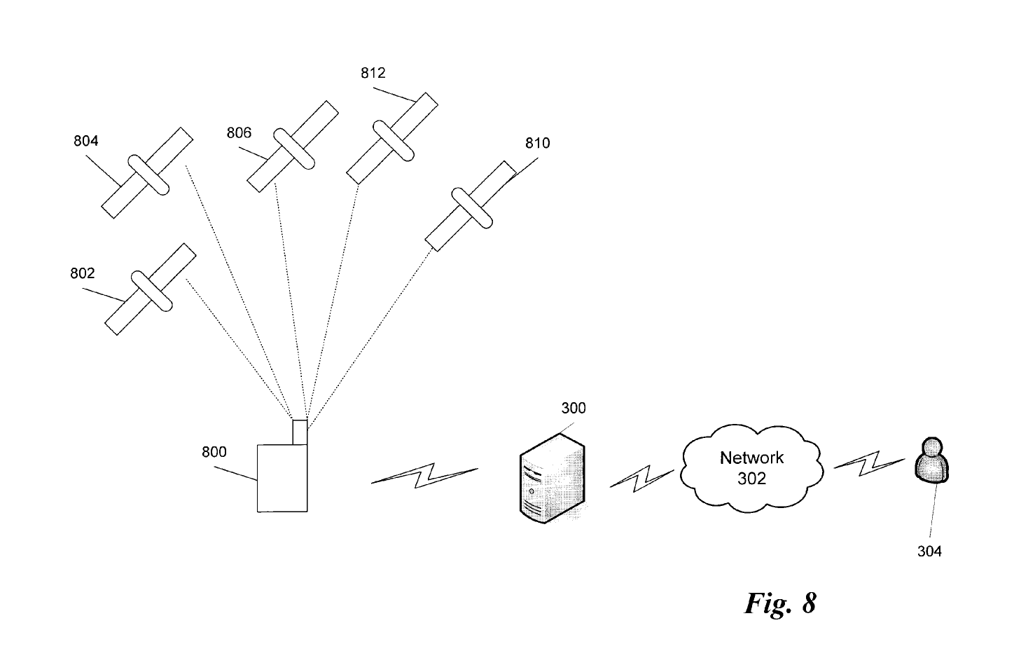

FIG. 8 is a schematic representation of the 3D position estimation system according to one example. The system may consist of five satellites 802, 804, 806, 810, 812. The system may include a Global Navigation Satellite System (GNSS) receiver 800. The satellites 802, 804, 806, 810, 812 broadcast signals that are received by the GNSS receiver 800. The GNSS receiver 800 may be located at the object 100 position. The satellites 802, 804, 806, 810, 812 are GPS satellites. The satellites may also be satellite based augmentation system (SBAS) satellites. The GNSS 800 receiver may be a personal navigation device (PND), a cellphone with built-in GPS functionality or any GPS device as would be understood by one of ordinary skill in the art. The GNSS receiver 800 may comprise an antenna, a processor, a memory to store GNSS signal received, a radio frequency front end module and a baseband digital signal processing (DSP) module. The GNSS receiver 800 may also include communication circuitry to transmit measurements to the server 300.

The positions of the five satellites are known and may be represented by (aᵢ, bᵢ, cᵢ) where i=1, . . . , 5. The pseudorange measurements may be represented by Ti, where i=1, . . . , 5. Tᵢ is the known travel time of the signal from satellite i as calculated by the GNSS receiver. ti, i=1, . . . , 5, may represent the unknown actual time traveled by the signal from satellite i. Thus, tᵢ=Tᵢ−τ. The unknown position of the GNSS receiver may be represented by (x,y,z).

The i-th pseudorange measurement may be expressed as

c(Tᵢ−τ)=\sqrt{(x−aᵢ)²+(y−bᵢ)²+(z−cᵢ)²} (16)

where c is the speed of light in vacuum or the propagation speed of the GNSS signal in the medium between the GNSS satellites and the receiver.

Squaring both sides of the pseudorange measurement equation (16), the following five equations can be written

(x−a₁)²+(y−b₁)²+(z−c₁)²=c²(T₁−τ) (17)

(x−a₂)²+(y−b₂)²+(z−c₂)²=c²(T₂−τ) (18)

(x−a₃)²+(y−b₃)²+(z−c₃)²=c²(T₃−τ) (19)

(x−a₄)²+(y−b₄)²+(z−c₄)²=c²(T₄−τ) (20)

(x−a₅)²+(y−b₅)²+(z−c₅)²=c²(T₅−τ) (21)

Expanding equations (17)-(21) and then subtracting equations (18)-(21) from equation (17) successively and rearranging, four expressions are obtained:

$$\begin{matrix}( {a}_{2} - {a}_{1} ) x + ( {b}_{2} - {b}_{1} ) y + ( {c}_{2} - {c}_{1} ) z = {c}^{2} τ {I}_{1} + \frac{1}{2} {B}_{1} & ( 22 ) \\ ( {a}_{3} - {a}_{1} ) x + ( {b}_{3} - {b}_{1} ) y + ( {c}_{3} - {c}_{1} ) z = {c}^{2} τ {I}_{2} + \frac{1}{2} {B}_{2} & ( 23 ) \\ ( {a}_{4} - {a}_{1} ) x + ( {b}_{4} - {b}_{1} ) y + ( {c}_{4} - {c}_{1} ) z = {c}^{2} τ {I}_{3} + \frac{1}{2} {B}_{3} & ( 24 ) \\ ( {a}_{5} - {a}_{1} ) x + ( {b}_{5} - {b}_{1} ) y + ( {c}_{5} - {c}_{1} ) z = {c}^{2} τ {I}_{4} + \frac{1}{2} {B}_{4} & ( 25 )\end{matrix}$$

where
L₁=T₂−T₁,
L₂=T₃−T₁,
L₃=T₄−T₁,
L₅=T₅−T₁,
B₁=c²(T₁²−T₂²)+(a₂²−a₁²)+(b₂²−b₁²)+(c₂²−c₁²),
B₂=c²(T₁²−T₃²)+(a₃²−a₁²)+(b₃²−b₁²)+(c₃²−c₁²),
B₃=c²(T₁²−T₄²)+(a₄²−a₁²)+(b₄²−b₁²)+(c₄²−c₁²) and
B₄=c²(T₁²−T₅²)+(a₅²−a₁²)+(b₅²−b₁²)+(c₅²−c₁²).

Multiplying (22) and (23) by J₂ and J₁ respectively, and then subtracting (23) from (22) and rearranging to cancel out z, the following expression is obtained:

L₂[(a₂−a₁)x+(b₂−b₁)y+(c₂−c₁)z]−L₁[(a₃−a₁)x+(b₃−b₁)y+(c₃−c₁)z]=½(B₁L₂−B₂L₁) (26)

Similarly, equations (22) and (24) are multiplied by J₃ and J₁ respectively, and then subtracting (24) from (22) and rearranging to cancel out τ, the following expression is obtained:

L₃[(a₂−a₁)x+(b₂−b₁)y+(c₂−c₁)z]−L₁[(a₄−a₁)x+(b₄−b₁)y+(c₄−c₁)z]=½(B₁L₃−B₃L₁) (27)

Finally, equations (22) and (25) are multiplied by J₄ and J₁ respectively, and then subtracting (25) from (22) and rearranging to cancel out τ, the following expression is obtained:

L₄[(a₂−a₁)x+(b₂−b₁)y+(c₂−c₁)z]−L₁[(a₅−a₁)x+(b₅−b₁)y+(c₅−c₁)z]=½(B₁L₄−B₄L₁) (28)

Equations (26)-(28) may be further simplified by defining the following variables:
L₁₁=L₂(a₂−a₁)−L₁(a₃−a₁),
L₁₂=L₂(b₂−b₁)−L₁(b₃−b₁),
L₁₃=L₂(c₂−c₁)−L₁(c₃−c₁),
L₁₄=½(B₁L₂−B₂L₁),
L₂₁=L₃(a₂−a₁)−L₁(a₄−a₁),
L₂₂=L₃(b₂−b₁)−L₁ (b₄−b₁),
L₂₃=L₃(c₂−c₁)−L₁(c₄−c₁),
L₂₄=½(B₁L₃−B₃L₁),
L₃₁=L₄(a₂−a₁)−L₁(a₅−a₁),
L₃₂=L₄(b₂−b₁)−L₁(b₅−b₁),
L₃₃=L₄(c₂−c₁)−L₁(c₅−c₁) and
L₃₄=½(B₁L₄−B₄L₁).

Thus, equations (26)-(28) may be written as:

L₁₁x+L₁₂y+L₁₃z=L₁₄ (29)

L₂₁x+L₂₂y+L₂₃z=L₂₄ (30)

L₃₁x+L₃₂y+L₃₃z=L₃₄ (31)

To further simplify, the following variables are introduced:
J₁=L₂₃L₁₁−L₁₃L₂₁
J₂=L₂₃L₁₂−L₁₃L₂₂,
J₃=L₂₃L₁₄−L₁₃L₂₄,
J₄=L₃₃L₁₁−L₁₃L₃₁,
J₅=L₃₃L₁₂−L₁₃L₃₂ and
J₆=L₃₃L₁₄−L₁₃L₃₄.
   Multiplying equations (29) and (30) by L₂₃ and L₁₃ respectively, and then subtracting (30) from (29) and rearranging to cancel out z yields

J₁x+J₂y=J₃ (32)

Similarity, equations (29) and (31) are multiplied by L₃₃ and L₁₃ respectively, and then subtracting (31) from (29) and rearranging to cancel out z yields

J₄x+J₅y=J₆ (33)

From (32) and (33), a solution for x independent of the other unknown, y, z and τ, is obtained:

$$x = \frac{{J}_{3} {J}_{5} - {J}_{2} {J}_{6}}{{J}_{1} {J}_{5} - {J}_{2} {J}_{4}} \qquad ( 34 )$$

Similarly, solutions for y, z and τ independent of the rest of the unknowns are obtained:

$$\begin{matrix}y = \frac{{J}_{1} {J}_{6} - {J}_{3} {J}_{4}}{{J}_{1} {J}_{5} - {J}_{2} {J}_{4}} & ( 35 ) \\ z = \frac{{K}_{1} {K}_{6} - {K}_{3} {K}_{4}}{{K}_{1} {K}_{5} - {K}_{2} {K}_{4}} & ( 36 )\end{matrix}$$

where
K₁=L₂₂L₁₁−L₁₂L₂₁,
K₂=L₂₂L₁₃−L₁₂L₂₃,
K₃=L₂₂L₁₄−L₁₂L₂₄,
K₄=L₃₂L₁₄−L₁₂L₃₁,
K₅=L₃₂L₁₃−L₁₂L₃₃ and
K₆=L₃₂L₁₄−L₁₂L₃₄.
   Finally the clock-offset may be expressed as:

$$τ = \frac{{N}_{3} {N}_{4} - {N}_{1} {N}_{6}}{{c}^{2} ( {N}_{1} {N}_{5} - {N}_{2} {N}_{4} )} \qquad ( 37 )$$

where
M₁=a₂−a₁,
M₂=a₃−a₁,
M₃=a₄−a₁,
M₄=a₅−a₁,
M₁₁=M₂(b₂−b₁)−M₁(b₃−b₁),
M₁₂=M₂(c₂−c₁)−M₁(c₃−c₁),
M₁₃=M₂(T₂−T₁)−M₁(T₃−T₁),
M₁₄=½(M₂B₁−M₁B₂),
M₂₁=M₃(b₂−b₁)−M₁(b₄−b₁),
M₂₂=M₃(c₂−c₁)−M₁(c₄−c₁),
M₂₃=M₃(T₂−T₁)−M₁(T₄−T₁),
M₂₄=½(M₃B₁−M₁B₃),
M₃₁=M₄(b₂−b₁)−M₁(b₅−b₁),
M₃₂=M₄(c₂−c₁)−M₁(c₅−c₁),
M₃₃=M₄(T₂−T₁)−M₁(T₅−T₁),
M₃₄=½(M₄B₁−M₁B₄),
N₁=M₂₁M₁₂−M₁₁M₂₂,
N₂=M₂₁M₁₃−M₁₁M₂₃,
N₃=M₂₁M₁₄−M₁₁M₂₄,
N₄=M₃₁M₁₂−M₁₁M₃₂,
N₅=M₃₁M₁₃−M₁₁M₃₃ and
N₆=M₃₁M₁₄−M₁₁M₃₄.

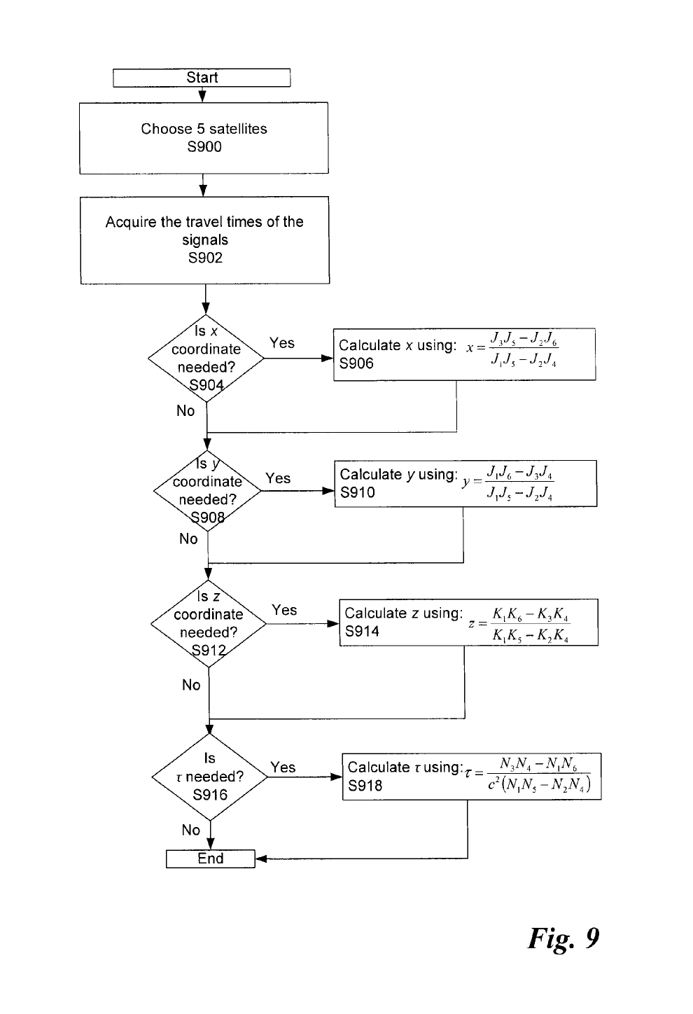

FIG. 9 is a flowchart that illustrates the method to find the 3D position of the object according to one example. At step S900, the server 300 may choose the five satellites that need to be used to find the 3D position. In one embodiment, the method to search for the five satellites may be that disclosed in U.S. Pat. No. 8,436,711B2 entitled “ENHANCING SEARCH CAPACITY OF GLOBAL NAVIGATION SATELLITE SYSTEM (GNSS) RECEIVERS” the entire disclosure of which is incorporated herein by reference. In this example, it is assumed that the satellites positions are known. The satellites positions can be stored in the server 300. At step S902, the server 300 may obtain the travel times of the signals from the satellites to the GNSS receiver 800. At step 904, the server 300 may check whether the x coordinate is needed. The user 304 may indicate which coordinates are needed to the server 300 via the network 302. The user 304 depending on the application may need only one coordinate from x, y and z coordinates or the clock-offset r. In response to determining that the x coordinate is needed, the server 300 compute the x coordinate using equation (34) at step S906. At step S908, the server 300 may check whether they coordinate is needed. In response to determining that they coordinate is needed, the server 300 compute they coordinate using equation (35) at step S910. At step S912, the server 300 may check whether the z coordinate is needed. In response to determining that the z coordinate is needed, the server 300 compute the z coordinated using equation (36) at step S912. At step S916, the server 300 may check whether the clock-offset τ is needed. In response to determining that the clock-offset τ is needed, the server 300 compute the clock offset τ using equation (37) at step S916.

A system which includes the features in the foregoing description provides numerous advantages to the users. In particular, the method and system determines the position of the object using exactly four TOA from four different stations. The present disclosure has the advantage of finding the exact location without ambiguities. Thus, the present disclosure provides an improvement to the technical field by finding the exact position without ambiguities and by reducing errors. In addition, the present disclosure has the advantage of finding only the needed components thus minimizing computation. Thus, the present disclosure improves the functioning of the server by increasing processing speed, decreasing power consumption and resulting in a chip area reduction. The presented method can be applied to indoor or outdoor localization. With the rapid development of wireless sensor networks, location information becomes critically essential and indispensable. In many applications, it is important to associate sensed data with locations. In addition, the presented method may also be used for localization using satellites. The presented method has the advantage to minimize the computational requirement for localization using satellites, which make it beneficial to use in locating high-speed vehicles. The method also finds the clock-offset without ambiguities.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

The above disclosure also encompasses the embodiments listed below.
(1) A method for determining a 3D position of a Global Navigation Satellite System (GNSS) receiver, including: obtaining a first, a second, a third, a fourth, and a fifth travel times of a signal from a first, a second, a third, a fourth, and a fifth satellites; determining, using processing circuitry and with reduced computation time, the 3D position of the GNSS receiver as a function of the first, the second, the third, the fourth, and the fifth travel times of the signal from the first, the second, the third, the fourth, and the fifth satellites, and positions of the first, second, third, fourth, and fifth satellites; determining, using the processing circuitry, a clock offset between synchronized clocks of the first, the second, the third, the fourth, and the fifth satellites and a clock of the GNSS receiver; and sending the 3D position of the GNSS receiver and the clock offset to an external device to provide enhanced position data to host applications.
(2) The method for determining the 3D position of the Global Navigation Satellite System (GNSS) receiver of (1), wherein the 3D position of the GNSS receiver is defined by x, y and z coordinates.
(3) The method for determining the 3D position of the GNSS receiver of (2), further including: calculating the x coordinate as a function of J₁, J₂, J₃, J₄, J₅ and J₆ where
   J₁=L₂₃L₁₁−L₁₃L₂₁,
   J₂=L₂₃L₁₂−L₁₃L₂₂,
   J₃=L₂₃L₁₄−L₁₃L₂₄,
   J₄=L₃₃L₁₁−L₁₃L₃₁,
   J₅=L₃₃L₁₂−L₁₃L₃₂,
   J₆=L₃₃L₁₄−L₁₃L₃₄,
   L₁₁=L₂(a₂−a₁)−L₁(a₃−a₁),
   L₁₂=L₂(b₂−b₁)−L₁(b₃−b₁),
   L₁₃=L₂(c₂−c₁)−L₁(c₃−c₁),
   L₁₄=½(B₁L₂−B₂L₁),
   L₂₁=L₂(a₂−a₁)−L₁(a₄−a₁),
   L₂₂=L₃(b₂−b₁)−L₁(b₄−b₁),
   L₂₃=L₃(c₂−c₁)−L₁(c₄−c₁),
   L₂₄=½(B₁L₃−B₃L₁),
   L₃₁=L₄(a₂−a₁)−L₁(a₅−a₁),
   L₃₂=L₄(b₂−b₁)−L₁(b₅−b₁),
   L₃₃=L₄(c₂−c₁)−L₁(c₅−c₁),
   L₃₄=½(B₁L₄−B₄L₁),
   L₁=T₂−T₁,
   L₂=T₃−T₁,
   L₃=T₄−T₁,
   L₅=T₅−T₁,
   B₁=c²(T₁²−T₂²)+(a₂²−a₁²)+(b₂²−b₁²)+(c₂²−c₁²),
   B₂=c²(T₁²−T₃²)+(a₃²−a₁²)+(b₃²−b₁²)+(c₃²−c₁²),
   B₃=c²(T₁²−T₄²)+(a₄²−a₁²)+(b₄²−b₁²)+(c₄²−c₁²),
   B₄=c²(T₁²−T₅²)+(a₅²−a₁²)+(b₅²−b₁²)+(c₅²−c₁²),
   T₁, T₂, T₃, T₄, and T₅ are the first, the second, the third, the fourth, and the fifth travel times of the signal from the first, the second, the third, the fourth, and the fifth satellites,
   a₁, b₁, c₁ are coordinates defining the 3D position of the first satellite,
   a₂, b₂, c₂ are the coordinates defining the 3D position of the second satellite,
   a₃, b₃, c₃ are the coordinates defining the 3D position of the third satellite,
   a₄, b₄, c₄ are the coordinates defining the 3D position of the fourth satellite,
   a₅, b₅, c₅ are the coordinates defining the 3D position of the fifth satellite, and
   c is the signal propagation speed of the signal in a medium between the first, the second, the third, the fourth, and the fifth satellites and the GNSS receiver.
(4) The method for determining the 3D position of the GNSS receiver of (3), wherein calculating the x coordinate includes applying

$$x = \frac{{J}_{3} {J}_{5} - {J}_{2} {J}_{6}}{{J}_{1} {J}_{5} - {J}_{2} {J}_{4}} .$$

(5) The method for determining the 3D position of the GNSS receiver of (3), further including: calculating the y coordinate as a function of J₁, J₂, J₃, J₄, J₅ and J₆.
(6) The method for determining the 3D position of the GNSS receiver of (5), wherein calculating the y coordinate includes applying

$$y = \frac{{J}_{1} {J}_{6} - {J}_{3} {J}_{4}}{{J}_{1} {J}_{5} - {J}_{2} {J}_{4}} .$$

(7) The method for determining the 3D position of the GNSS receiver of (3), further including: calculating the z coordinate as a function of K₁, K₂, K₃, K₄, K₅ and K₆, where
   K₁=L₂₂L₁₁−L₁₂L₂₁,
   K₂=L₂₂L₁₃−L₁₂L₂₃,
   K₃=L₂₂L₁₄−L₁₂L₂₄,
   K₄=L₃₂L₁₁−L₁₂L₃₁,
   K₅=L₃₃L₁₃−L₁₂L₃₃, and
   K₆=L₃₂L₁₄−L₁₂L₃₄.
(8) The method for determining the 3D position of the GNSS receiver of (7), wherein calculating the z coordinate includes applying

$$z = \frac{{K}_{1} {K}_{6} - {K}_{3} {K}_{4}}{{K}_{1} {K}_{5} - {K}_{2} {K}_{4}} .$$

(9) The method for determining the 3D position of the GNSS receiver of (3), further including: calculating the clock offset as a function of N₁, N₂, N₃, N₄, N₅, N₆ and c where
   M₁=a₂−a₁,
   M₂=a₃−a₁,
   M₃=a₄−a₁,
   M₄=a₅−a₁,
   M₁₁=M₂(b₂−b₁)−M₁(b₃−b₁),
   M₁₂=M₂(c₂−c₁)−M₁(c₃−c₁),
   M₁₃=M₂(T₂−T₁)−M₁(T₃−T₁),
   M₁₄=½(M₂B₁−M₁B₂),
   M₂₁=M₃(b₂−b₁)−M₁(b₄−b₁),
   M₂₂=M₃(c₂−c₁)−M₁(c₄−c₁),
   M₂₃=M₃(T₂−T₁)−M₁(T₄−T₁),
   M₂₄=½(M₃B₁−M₁B₃),
   M₃₁=M₄(b₂−b₁)−M₁(b₅−b₁),
   M₃₂=M₄(c₂−c₁)−M₁(c₅−c₁),
   M₃₃=M₄(T₂−T₁)−M₁(T₅−T₁),
   M₃₄=½(M₄B₁−M₁B₄),
   N₁=M₂₁M₁₂−M₁₁M₂₂,
   N₂=M₂₁M₁₃−M₁₁M₂₃,
   N₃=M₂₁M₁₄−M₁₁M₂₄,
   N₄=M₃₁M₁₂−M₁₁M₃₂,
   N₅=M₃₁M₁₃−M₁₁M₃₃ and
   N₆=M₃₁M₁₄−M₁₁M₃₄.
(10) The method for determining the 3D position of the GNSS receiver of (9), wherein calculating the clock offset includes applying

$$τ = \frac{{N}_{3} {N}_{4} - {N}_{1} {N}_{6}}{{c}^{2} ( {N}_{1} {N}_{5} - {N}_{2} {N}_{4} )}$$

where τ is the clock offset.
(11) A system for determining a 3D position of a Global Navigation Satellite System (GNSS) receiver, including: at least five satellites; a GNSS receiver; and processing circuitry configured to obtain, a first, a second, a third, a fourth, and a fifth travel times of a signal from a first, a second, a third, a fourth, and a fifth satellites, determine the 3D position of the GNSS receiver as a function of the first, the second, the third, the fourth, and the fifth travel times of the signal from the first, the second, the third, the fourth, and the fifth satellites, and positions of the first, second, third, fourth, and fifth satellites, determine a clock offset between synchronized clocks of the first, the second, the third, the fourth, and the fifth satellites and a clock of the GNSS receiver, and send the 3D position of the GNSS receiver and the clock offset to an external device to provide enhanced position data to host applications.

1. A method for determining a 3D position of a Global Navigation Satellite System (GNSS) receiver, the method comprising:
obtaining a first, a second, a third, a fourth, and a fifth travel times of a signal from a first, a second, a third, a fourth, and a fifth satellites;
determining, using processing circuitry and with reduced computation time, the 3D position of the GNSS receiver as a function of the first, the second, the third, the fourth, and the fifth travel times of the signal from the first, the second, the third, the fourth, and the fifth satellites, and positions of the first, second, third, fourth, and fifth satellites;
determining, using the processing circuitry, a clock offset between synchronized clocks of the first, the second, the third, the fourth, and the fifth satellites and a clock of the GNSS receiver; and
sending the 3D position of the GNSS receiver and the clock offset to an external device to provide enhanced position data to host applications.

2. The method of claim 1, wherein the 3D position of the GNSS receiver is defined by x, y and z coordinates.

3. The method of claim 2, further comprising:
calculating the x coordinate as a function of J₁, J₂, J₃, J₄, J₅ and J₆
where
J₁=L₂₃L₁₁−L₁₃L₂₁,
J₂=L₂₃L₁₂−L₁₃L₂₂,
J₃=L₂₃L₁₄−L₁₃L₂₄,
J₄=L₃₃L₁₁−L₁₃L₃₁,
J₅=L₃₃L₁₂−L₁₃L₃₂,
J₆=L₃₃L₁₄−L₁₃L₃₄,
L₁₁=L₂(a₂−a₁)−L₁(a₃−a₁),
L₁₂=L₂(b₂−b₁)−L₁(b₃−b₁),
L₁₃=L₂(c₂−c₁)−L₁(c₃−c₁),
L₁₄=½(B₁L₂−B₂L₁),
L₂₁=L₂(a₂−a₁)−L₁(a₄−a₁),
L₂₂=L₃(b₂−b₁)−L₁(b₄−b₁),
L₂₃=L₃(c₂−c₁)−L₁(c₄−c₁),
L₂₄=½(B₁L₃−B₃L₁),
L₃₁=L₄(a₂−a₁)−L₁(a₅−a₁),
L₃₂=L₄(b₂−b₁)−L₁(b₅−b₁),
L₃₃=L₄(c₂−c₁)−L₁(c₅−c₁),
L₃₄=½(B₁L₄−B₄L₁),
L₁=T₂−T₁,
L₂=T₃−T₁,
L₃=T₄−T₁,
L₅=T₅−T₁,
B₁=c²(T₁²−T₂²)+(a₂²−a₁²)+(b₂²−b₁²)+(c₂²−c₁²),
B₂=c²(T₁²−T₃²)+(a₃²−a₁²)+(b₃²−b₁²)+(c₃²−c₁²),
B₃=c²(T₁²−T₄²)+(a₄²−a₁²)+(b₄²−b₁²)+(c₄²−c₁²),
B₄=c²(T₁²−T₅²)+(a₅²−a₁²)+(b₅²−b₁²)+(c₅²−c₁²),
T₁, T₂, T₃, T₄, and T₅ are the first, the second, the third, the fourth, and the fifth travel times of the signal from the first, the second, the third, the fourth, and the fifth satellites,
a₁, b₁, c₁ are coordinates defining the 3D position of the first satellite,
a₂, b₂, c₂ are the coordinates defining the 3D position of the second satellite,
a₃, b₃, c₃ are the coordinates defining the 3D position of the third satellite,
a₄, b₄, c₄ are the coordinates defining the 3D position of the fourth satellite,
a₅, b₅, c₅ are the coordinates defining the 3D position of the fifth satellite, and
c is the signal propagation speed of the signal in a medium between the first, the second, the third, the fourth, and the fifth satellites and the GNSS receiver.

4. The method of claim 3, wherein calculating the x coordinate includes applying
$$x = \frac{{J}_{3} {J}_{5} - {J}_{2} {J}_{6}}{{J}_{1} {J}_{5} - {J}_{2} {J}_{4}} .$$

5. The method of claim 3, further comprising:
calculating the y coordinate as a function of J₁, J₂, J₃, J₄, J₅ and J₆.

6. The method of claim 5, wherein calculating the y coordinate includes applying
$$y = \frac{{J}_{1} {J}_{6} - {J}_{3} {J}_{4}}{{J}_{1} {J}_{5} - {J}_{2} {J}_{4}} .$$

7. The method of claim 3, further comprising:
calculating the z coordinate as a function of K₁, K₂, K₃, K₄, K₅ and K₆,
where
K₁=L₂₂L₁₁−L₁₂L₂₁,
K₂=L₂₂L₁₃−L₁₂L₂₃,
K₃=L₂₂L₁₄−L₁₂L₂₄,
K₄=L₃₂L₁₄−L₁₂L₃₁,
K₅=L₃₂L₁₃−L₁₂L₃₃, and
K₆=L₃₂L₁₄−L₁₂L₃₄.

8. The method of claim 7, wherein calculating the z coordinate includes applying
$$z = \frac{{K}_{1} {K}_{6} - {K}_{3} {K}_{4}}{{K}_{1} {K}_{5} - {K}_{2} {K}_{4}} .$$

9. The method of claim 3, further comprising:
calculating the clock offset as a function of N₁, N₂, N₃, N₄, N₅, N₆ and c
where
M₁=a₂−a₁,
M₂=a₃−a₁,
M₃=a₄−a₁,
M₄=a₅−a₁,
M₁₁=M₂(b₂−b₁)−M₁(b₃−b₁),
M₁₂=M₂(c₂−c₁)−M₁(c₃−c₁),
M₁₃=M₂(T₂−T₁)−M₁(T₃−T₁),
M₁₄=½(M₂B₁−M₁B₂),
M₂₁=M₃(b₂−b₁)−M₁(b₄−b₁),
M₂₂=M₃(c₂−c₁)−M₁(c₄−c₁),
M₂₃=M₃(T₂−T₁)−M₁(T₄−T₁),
M₂₄=½(M₃B₁−M₁B₃),
M₃₁=M₄(b₂−b₁)−M₁(b₅−b₁),
M₃₂=M₄(c₂−c₁)−M₁(c₅−c₁),
M₃₃=M₄(T₂−T₁)−M₁(T₅−T₁),
M₃₄=½(M₄B₁−M₁B₄),
N₁=M₂₁M₁₂−M₁₁M₂₂,
N₂=M₂₁M₁₃−M₁₁M₂₃,
N₃=M₂₁M₁₄−M₁₁M₂₄,
N₄=M₃₁M₁₂−M₁₁M₃₂,
N₅=M₃₁M₁₃−M₁₁M₃₃ and
N₆=M₃₁M₁₄−M₁₁M₃₄.

10. The method of claim 9, wherein calculating the clock offset includes applying
$$τ = \frac{{N}_{3} {N}_{4} - {N}_{1} {N}_{6}}{{c}^{2} ( {N}_{1} {N}_{5} - {N}_{2} {N}_{4} )}$$
where τ is the clock offset.

11. A system for determining a 3D position of a Global Navigation Satellite System (GNSS) receiver, the system comprising:
at least five satellites;
a GNSS receiver; and
processing circuitry configured to
obtain, a first, a second, a third, a fourth, and a fifth travel times of a signal from a first, a second, a third, a fourth, and a fifth satellites,
determine the 3D position of the GNSS receiver as a function of the first, the second, the third, the fourth, and the fifth travel times of the signal from the first, the second, the third, the fourth, and the fifth satellites, and positions of the first, second, third, fourth, and fifth satellites,
determine a clock offset between synchronized clocks of the first, the second, the third, the fourth, and the fifth satellites and a clock of the GNSS receiver, and
send the 3D position of the GNSS receiver and the clock offset to an external device to provide enhanced accurate position data to host applications.
